(19) United States
(12) Patent Application Publication
(10) Pub. No.: US 2021/0237777 A1
(43) Pub. Date: Aug. 5, 2021

(54) DEVICES AND METHODS FOR CHANNELIZING VEHICULAR TRAFFIC AND ENHANCING WORKZONE SAFETY

(71) Applicants: Adam Jordan Selevan, Laguna Beach, CA (US); Daniel Joseph Selevan, Laguna Beach, CA (US); James R. Selevan, Laguna Beach, CA (US)

(72) Inventors: Adam Jordan Selevan, Laguna Beach, CA (US); Daniel Joseph Selevan, Laguna Beach, CA (US); James R. Selevan, Laguna Beach, CA (US)

(21) Appl. No.: 17/145,372

(22) Filed: Jan. 10, 2021

Related U.S. Application Data
(60) Provisional application No. 62/959,927, filed on Jan. 11, 2020.

(51) Int. Cl. B60W 60/00; B60W 50/14; H04W 12/00; H04W 84/18; G06F 8/65; G06F 8/71; G06K 9/00

(52) U.S. Cl. CPC B60W 60/00188; B60W 50/14; H04W 12/009; H04W 84/18; B60W 2050/146; G06F 8/71; G06K 9/00805; B60W 2554/4049; G06F 8/65

(57) ABSTRACT

Devices and methods useable for delineating bounds or path(s) of travel, channelizing vehicular traffic and enhancing safety in highway work zones.

### RELATED APPLICATION

This application claims priority to U.S. Provisional patent Application No. 62/959,927 entitled Internally Illuminated Traffic Channelizing Devices filed Jan. 11, 2020, the entire disclosure of which is expressly incorporated herein by reference.

### FIELD OF THE INVENTION

The present invention relates generally to the fields of electronics, traffic engineering and public safety and more particularly to devices and methods useable for delineating bounds or path(s) of travel, channelizing vehicular traffic and enhancing safety in highway work zones.

### BACKGROUND

Pursuant to 37 CFR 1.71(e), this patent document contains material which is subject to copyright protection and the owner of this patent document reserves all copyright rights whatsoever.

As used herein the term “work zone” shall be interpreted to include, but is not necessarily limited to, any area(s) or site(s) on or near roadways or paths of vehicular travel wherein one or more of the following is/are present: workers; pedestrians; parked or operating vehicles or equipment; ongoing or planned police, fire, emergency medical, construction, repair or other operations; full or partial roadway closures; hazardous items or materials; an accident or scene of emergency situation; police or law enforcement activity such as a DUI, immigration or document checkpoint, etc.

It is common practice to place various types of warning or vehicular channelizing devices (e.g., cones, delineators, barrels, fencing, flares, warning lights, signs, electronic roadside displays, etc.) in or near work zones to warn oncoming vehicular traffic and/or to assist oncoming vehicular traffic in navigating around and/or avoiding incursion into, such work zones.

The increasing commonality of vehicles equipped with GPS navigation systems, automated driver warning/assist systems and autopilot or autonomous driving systems has given rise to a need for new devices and methods for promoting work zone safety by signaling or otherwise providing notice to oncoming vehicles of work zone locations and/or other hazards. Guiding vehicles, pedestrians, bicycles, or other moving objects through congested or dangerous areas requires easily identifiable cues. These cues may be in the form of signage (yield, stop, speed limit, arrows, for example) or delineators (traffic cones, barrels, vertical panels and the like). During daylight hours the sensory and neurological systems of humans can be able to establish relative distance and depth of field. However, after darkness falls, the ability of some persons to accurately establish depth of field, distance, and approach-speed may be reduced or compromised. These limitations are consistent with statistics indicating that a disproportionate number of vehicle mishaps during dark hours.

As vehicles become more insulated from road noise, surface feedback, and easier to control at higher speeds, drivers are more easily distracted. Attention is focused inward rather than on the road environment ahead. Combine this with an aging infrastructure and the need for repair, workers, law enforcement, fire crews, utility personnel, etc., are in greater danger. As state Departments of Transportation experience increasing numbers of tragedies, Smart Work Zone initiatives have become the norm. While vehicles have become “smarter”, many roadways remain untouched by technology. Devices and methods to lower the cost of Smart Work Zones and other asset monitoring, as well as preparing for autonomous vehicle navigation are described in this application.

Furthermore, with the advent of new technology and the approach of autonomous vehicles, drivers will rely to a greater degree on automated systems. Ground Truth, a term referring to real-time position, geometry of work areas, obstacles, and pedestrian location will be required for automated systems to safely navigate a transient change in pre-mapped roadways. Information pertaining to Ground Truth presented to autonomous vehicles will require local sensors and communication networks. While electronic systems are able to filter noise and undesirable input, humans may be confused by such. Upon entering a work zone at 120 kilometers-per-hour (70 mph), for example, the myriad of flashing lamps, work vehicles, work lamps, delineators, barriers, and personnel can present a chaotic scene that requires immediate mental organization. A system that enhances guidance in a “calming” way provides a safe alternative for today's drivers and pedestrians.

### SUMMARY

In accordance with one aspect, the present disclosure includes a system which comprises: a plurality of node devices positionable on or near a roadway or path of vehicular travel, each device comprising electronic circuitry configured to cause said plurality of node devices to communicate as a mesh network; and a gateway device configured for wired or wireless communication with a remote-control center or data receiver; said gateway device being further configured to receive data from said node devices and to transmit said data or information based on said data to the remotely located control center or data receiver. In some embodiments, the node devices and/or the gateway device(s) may also comprise or may be attached/affixed to traffic channeling/marking or safety devices (e.g., cones, barrels, delineators, tubes, reflectors, lamps, barricades, vibration strips, fences, signs, electronic displays, poles, posts, pillars, etc.) In some embodiments, the node devices and/or the gateway device(s) may include lamps or other signal emitters that emit visible or infrared light, sound or other signals. In some embodiments, the gateway device may additionally function as one of the node devices of the mesh network. In embodiments where the node devices comprise lamps or signal emitters, the mesh network communication may cause the lamps or signal emitters of the node devices to emit light or signals (e.g., flashes of visible or infrared light or sounds) in a preset pattern or order. In some embodiments, the electronic circuitry of each node device and/or the gateway device(s) may comprise one or more of: a GPS antenna, GPS (e.g., GNSS) receiver, MCU transceiver, accelerometer or tilt sensor, voltage regulator, LED driver, temperature sensor and humidity sensor. In some embodiments, the node devices may be configured to detect, and the gateway device(s) may be configured to in turn notify the control center or data receiver of, of the occurrence of an event such as, for example, a change in the location of a node and/or gateway device; a change in functional status of a node and/or gateway device; a malfunction or cessation of function of a node and/or gateway device; and a movement or tilting of a node and/or gateway device. In some embodiments, the node devices may be configured to monitor, and the gateway device may be configured to in turn notify the control center or data receiver of, information selected from: on/off status of a node and/or gateway device; battery charge status of a node and/or gateway device; weather at the location of a node and/or gateway device; and temperature at the location of a node and/or gateway device. In some embodiments, the gateway device(s) is/are configured to receive from a remote location, and to intern transmit to the node devices, at least one type of signal or data to cause the node devices to perform a function selected from: turn the node devices from off to on; turn the node devices from on to off; and cause the a change in the type, color, order, program, timing, pattern or other characteristic of visible or other signals emitted by the node devices. In some embodiments, the gateway device(s) may be configured to receive from a remote location and to, in turn, transmit to the node devices a software or firmware update or other data or information. In some embodiments a control center or data receiver that receives data from the gateway device(s) may either: a) transmit some or all of the data that it receives from the gateway device(s) to vehicles equipped to receive such data or b) transmit some or all of the data it receives from the gateway device(s) to a second control center or data receiver which may, in turn, transmit some or all of that data to vehicles equipped to receive such data. In some embodiments a Geofence or other method may be employed to cause said data to be received or processed only by vehicles within a predetermined distance of the networked node devices or within a defined area or region (e.g., within a Geofence). In some embodiments, data may be transmitted to a vehicle equipped with a GPS map display and the data may cause a warning, symbol, indicator, code or mark to appear on the GPS map display. In some embodiments, data may be transmitted to a vehicle equipped with an autopilot or autonomous control system and the data may cause the autopilot or autonomous control system to cause the vehicle to reduce speed and/or perform a maneuver such as to navigate around an object or area. In some embodiments, data may be transmitted to a vehicle that is equipped with an automated driver assist system and the data may cause the automated driver assist system to issue a visual, audible, tactile or other prompt, notification or warning to a driver of the vehicle. The present disclosure includes a method for using this device comprising the steps of: positioning said a plurality of node devices at locations on or near the roadway or path of vehicular travel; causing or enabling the node devices to communicate as a mesh network; and causing or enabling the gateway device to receive data from said node devices and to transmit said data or information based on said data to the remotely located control center or data receiver.

In accordance with another aspect, the present disclosure includes a system of node devices which may be used for networking of a plurality of traffic channelizing/marking devices, wherein each of said node devices comprises a housing (e.g, a box, canister, enclosure, frame, etc.) that is attachable to a traffic channelizing/marking device, a battery and electronic circuitry comprising at least one sensor for sensing a condition or event and radiofrequency communication apparatus configured to enable the device to function as a node of a mesh network comprising a plurality of said devices. In some embodiments each node device may communicate notification of condition(s) or event(s) sensed by its sensor(s) to other node device(s) of the mesh network. In some embodiments, the sensor(s) may comprises at least one type of sensor selected from: temperature sensors, humidity sensors, accelerometers, tilt sensors and sensors for monitoring status of the battery. In some embodiments, the node device(s) may further comprise at least one light emitter for emitting visible or infrared light. In some embodiments, the node device(s) may have adhesive surface(s) for adhering that node device(s) to the traffic channelizing/marking device(s). In some embodiments, the system may further include gateway device(s) configured to receive signals from one or more of the node devices and to transmit such signal, or data based on such signal, to a remote control center or data receiver by cellular, telephonic, internet, fiber-optic or other wired or wireless communication. In some embodiments the gateway device(s) may also comprise a battery and a housing configured for attachment to one of said traffic channelizing/marking devices. In some embodiments, the gateway device(s) may also comprise electronic circuitry positioned within the housing, said electronic circuitry comprising at least one sensor for sensing a condition or event and radiofrequency communication apparatus configured to enable the gateway device to function not only as a gateway device but also as a node of said mesh network. In some embodiments, the node device(s) may have electronic circuitry that includes one or more of: a GPS antenna; a GPS (e.g., GNSS) receiver; an MCU transceiver; an accelerometer or tilt sensor; a voltage regulator; an LED driver and at least one LED; a temperature sensor and humidity sensor. In some embodiments, a gateway device that additionally functions as a node device may have apparatus for cellular, telephonic, internet, fiber-optic or other wired or wireless communication with a control center or data receiver as well as one or more of: a GPS antenna; a GPS (e.g., GNSS) receiver; an MCU transceiver; an accelerometer or tilt sensor; a voltage regulator; an LED driver and at least one LED; a temperature sensor and humidity sensor. In some embodiments, the housing may be configured to interchangeably accommodate either a) the node device electronic circuitry or b) the gateway device electronic circuitry. In embodiments wherein a node device and or a gateway device includes a temperature or humidity sensor, the housing may include an opening or vent configured to facilitate sensing of temperature or humidity outside of the housing by the temperature or humidity sensor. In some embodiments, the node device(s) and or gateway device(s) may include solar collector(s) and solar harvester component(s) or apparatus for solar charging of the battery. The present disclosure includes a method for using these node devices comprising the steps of: attaching a plurality of said node devices to a plurality of traffic channelizing/marking devices; and causing or enabling the sensors of the node devices to operate as a mesh network wherein the sensors of the node devices sense conditions or events and communicate data or information relating to sensed conditions or events to others of said node devices.

In accordance with another aspect, the present disclosure includes an illumination device for casting light (e.g., visible or infrared light) into an interior of a traffic channelizing/marking device (e.g, a cone, barrel, delineator, tube, reflector, barricade, vibration strip, fence, sign, electronic display, pole, post, pillar, etc.) that is fully or partially translucent such that at least some of the light cast by the illuminating device into the interior of the traffic channelizing/marking device will pass though a translucent wall or other translucent portion of the traffic channelizing/marking device. In some embodiments, the illumination device may further comprising electronic circuitry to send and receive data from others of said illuminating devices to thereby cause a plurality of said illuminating devices to operate as nodes of a mesh network. In a system wherein a plurality of these illuminating devices are operating as nodes of a mesh network, the system may further comprise gateway device(s) configured to receive data from the illuminating devices (nodes) and to transmit the data, or information based on the data, via cellular, telephonic, internet, fiber-optic or other wired or wireless communication, to a control center or data receiver. In some embodiments, the gateway device(s) may also include one or said illumination devices such that the gateway device(s) may also function as nodes of the mesh network. In some embodiments, each illuminating device (node) may have electronic circuitry which comprises at least one of: a GPS antenna, GPS (e.g., GNSS) receiver, MCU transceiver; accelerometer or tilt sensor, voltage regulator, LED driver, temperature sensor and humidity sensor. In some embodiments, of the system, any gateway device(s) that also function as node device(s) may have, in addition to the apparatus for cellular or fiber-optic communication, electronic circuitry comprising at least one of: a GPS antenna, GPS (e.g., GNSS) receiver, MCU transceiver; accelerometer or tilt sensor, voltage regulator, LED driver, temperature sensor and humidity sensor. In some embodiments of the system, the illuminating devices (nodes) may be configured to detect, and the gateway device may be configured to in turn notify the control center or data receiver of, of the occurrence of an event selected from: a change in the location of an illuminating device; a change in functional status of an node device; a malfunction or cessation of function of an illuminating device; and a movement or tilting of an illuminating device. In some embodiments of the system, the illuminating devices (nodes) are configured to monitor, and the gateway device is configured to in turn notify the control center or data receiver of, at least one status or condition selected from: on/off status of an illuminating device; battery charge status of an illuminating device; weather at the location of an illuminating device; humidity at the location of the illuminating device; and temperature at the location of an illuminating device. The present disclosure includes a method for using this illumination device comprising the step of: positioning the illuminating device on a traffic channelizing or marking device such that the illuminating device casts light into an interior of the traffic channelizing/marking device and at least some of the light cast into the interior of the traffic channelizing/marking device passes through a fully or partially translucent wall of the traffic channelizing/marking device and the electronic circuitry of the illuminating device sends and receives data from other illuminating devices to cause a plurality of said illuminating devices to operate as nodes of a mesh network.

In accordance with another aspect, the present disclosure includes an internally lit device useable for traffic channeling or marking (e.g, a cone, barrel, delineator, tube, reflector, barricade, vibration strip, fence, sign, electronic display, pole, post, pillar, etc.) wherein the traffic channeling or marking device comprises at least one side wall which is configured so that inner surface(s) of said at least one side wall define an inner space within the device; and at least one removable or permanently affixed illuminating device for casting light onto the inner surface(s) of said at least one side wall; wherein said at least one side wall is fully translucent or has portion(s) which is/are translucent such that at least some of the light cast onto the inner surface(s) of said at least one side wall will pass through said at least one side wall so as to be visible by persons approaching the device; and wherein said at least one side wall and said at least one illuminating device are configured such that a plurality of said devices may be stacked, one atop another, without requiring removal of said at least one illuminating device prior to stacking. In some embodiments, this device may have a side wall that is conical, frusto-conical, round, tiered or a plurality of side walls configured such that said inner space is polygonal in cross-section and the side wall(s) of such device may be tapered (e.g., narrower at the top wider at the bottom), perforated, vented, provided with spacers or stand-off structures or otherwise configured to allow a plurality of the devices to be stacked one on top another and subsequently unstacked, without the devices becoming locked or held in the stacked positions by the formation of negative pressure within the devices. In some embodiments, the illuminating device is positionable at a top end of the traffic channeling/marking device and casts light downwardly within its inner space while in other embodiments, the illuminating device may be positioned at a bottom end of the traffic channeling/marking device and casts light upwardly within its inner space. In some embodiments, the illumination device may include least one sensor for sensing at least one event, condition or variable selected from: the device being impacted, the device being knocked over; incursion of a vehicle into a zone marked by the device, temperature and/or other weather conditions at the location of the device; wind velocity and/or direction at the location of the device; speed of vehicles traveling past the device; size or weight of vehicles traveling past the device; charge status of a power source which powers said at least one illuminating device and functioning of said at least one illuminating device. In some embodiments, the illuminating device may include a transmitter for transmitting data that illuminating device to other illuminating devices or to a remote location such as a control center or data receiver. In some embodiments, the illuminating device may have a rechargeable power supply capable of being recharged while the illuminating device remains attached to a traffic channeling/marking device and, in some embodiments, while the traffic channeling/marking devices with attached illuminating devices) remain stacked one atop another. Some embodiments may include a charging device that is useable for charging the rechargeable power supplies of a number of the illuminating devices while attached to traffic channelizing/marking devices that are stacked one atop another. In some such embodiments, electrodes of adjacently positioned illuminating devices contact each other when the devices are stacked one atop another and the charging device may be configured to connect to one of the illuminating devices to deliver changing energy to all of the illuminating devices in series. In other embodiments, electrodes of adjacently positioned illuminating devices need not contact each other when the devices are stacked one atop another and the charging device may be configured to connect to each illuminating device so as to deliver changing energy to the illuminating devices in parallel. In this regard, the illuminating devices have channels, which become aligned when the devices are stacked one atop another and the charging device may comprise an elongate charging member which is insertable though the aligned channels while the devices are stacked one atop another. The illuminating devices and the elongate charging member may be equipped with electrodes which are configured such that, when the elongate changing member is inserted through the channels, electrodes of the charging member will contact electrodes of each illuminating device so as to deliver charging energy from the elongate changing member to the rechargeable power supply of each illuminating device, in parallel, while the devices are stacked one atop another. Each illuminating device may have a first emitter electrode on one side of its channel and a second emitter electrode on an opposite side of its channel and the elongate charging member may have an elongate insulator, a negative charging electrode on one side of the insulator and a positive charging electrode on a second side of the insulator such that the electrodes and the insulator are configured to preclude both the first and second electrodes of any one of the illuminating devices from concurrently contacting either the negative charging electrode or the positive charging electrode. In some embodiments, inductive charging may be used to simultaneously change all of the stacked illuminating devices. The present disclosure includes a method for storing a plurality of these internally lit devices comprising the step of stacking said internally lit devices, one atop another, without removing the illuminating devices prior to the stacking. In some embodiments, the method further comprises the step of charging power supplies of the internally lit devices while they remain stacked one atop another.

Still further aspects and details of the present disclosure may be understood from, but shall not be limited by, the accompanying figures and the detailed description below.

### BRIEF DESCRIPTION OF THE DRAWINGS

The following detailed description and examples are provided for the purpose of non-exhaustively describing some, but not necessarily all, examples or embodiments of the invention, and shall not limit the scope of the invention in any way.

FIG. 1 shows a side view of one embodiment of an illuminating device of the present invention.

FIG. 1A is a bottom end view of the illuminating device of FIG. 1

FIG. 2 shows one embodiment of a charging device of the present invention.

FIG. 2A is a cross-sectional view through Line A-A of FIG. 2.

FIG. 3A shows a plurality of traffic cones stacked one atop another, with the top two cones appearing in longitudinal sectional view.

FIG. 3B is a partial cut-away view of a plurality of traffic cones stacked one atop another with illumination devices attached to each traffic cone.

FIG. 3C is a longitudinal sectional view of the stacked devices of in FIG. 3B.

FIG. 3D is a schematic diagram of the stacked devices of FIG. 3B with the charging device inserted through aligned channels of the illumination devices.

FIG. 3E is a cross-sectional view of an illumination device having the charging device operatively inserted therein.

FIG. 4 is a side sectional view of an alternative embodiment of the illuminating device of FIG. 1 incorporating a first (node) type of circuit board, which is alternatively useable in a variety of other devices in addition to the illuminating device shown.

FIG. 5 is a diagram of a second (gateway) type of circuit board useable in the various devices, including the illumination device of FIG. 4.

FIG. 6 is a side sectional view of a housing device which may incorporate either a first (node) type of circuit board, an example of which is shown in FIG. 4, or a second (gateway) type of circuit board, an example of which is shown in FIG. 5.

FIG. 7 is a diagram showing one non-limiting example of a safe highway work zone and method for using a number of devices of the present disclosure.

FIG. 8 is an electrical diagram of a radiofrequency engine component useable in devices of the present disclosure.

FIG. 9 is an electrical diagram of a radiofrequency extender component useable in devices of the present disclosure.

FIG. 10 is an electrical diagram of circuitry for an input-output expander (I/O expander) useable in devices of the present disclosure.

FIG. 11 is an electrical diagram of temperature sensor, humidity sensor and accelerometer components useable in devices of the present disclosure.

FIG. 12 is an electrical diagram of a GPS GNSS system useable in devices of the present disclosure.

FIG. 13 is an electrical diagram of a solar harvester component useable in devices of the present disclosure.

FIG. 14 is an electrical diagram of circuitry relating to GPS GNSS, Particle modem and serial translator components useable in devices of the present disclosure.

FIG. 15 is an electrical diagram of a cellular modem component useable in devices of the present disclosure.

FIG. 16 is an electrical diagram of circuitry for tactile switches, indicator LEDs, and photo sensing circuitry useable in devices of the present disclosure.

### DETAILED DESCRIPTION

The following detailed description and the accompanying figures to which it refers are intended to describe some, but not necessarily all, examples or embodiments of the invention. The described embodiments are to be considered in all respects as being illustrative but not restrictive. The contents of this detailed description and the accompanying figures do not limit the scope of the invention in any way.

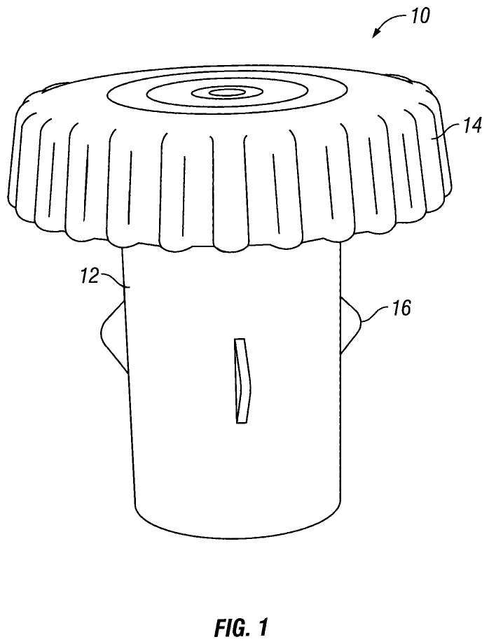

The accompanying FIGS. 1 through 3E show certain non-limiting examples of devices of the present invention, including one embodiment of an illumination device 10 which is useable for internally lighting stackable traffic cones C and a charging device 50 which is useable for charging rechargeable batteries 28 of each illumination device.

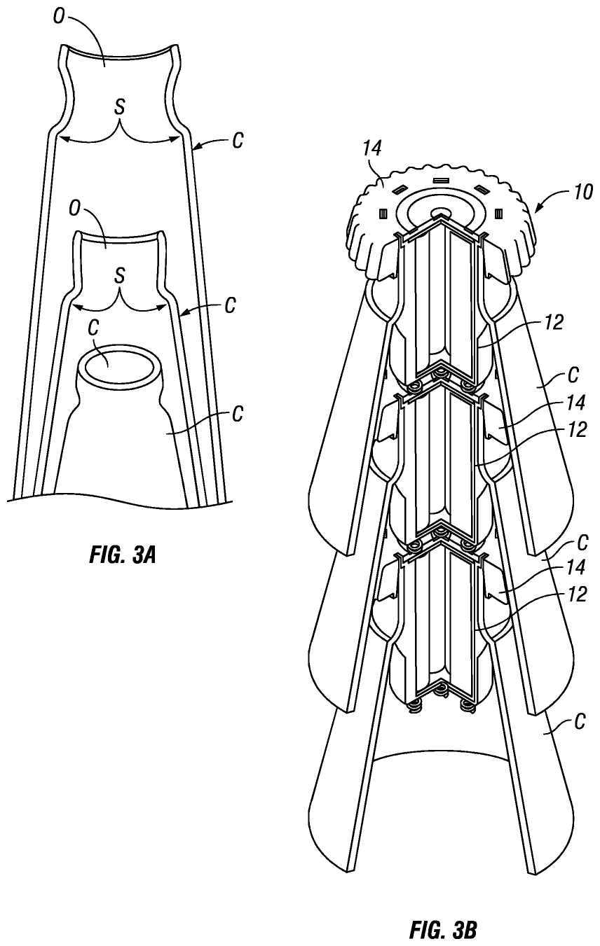

As seen in FIGS. 1 and 1A, this embodiment of the illumination devices 10 comprises a body portion 12 and a cap 14. Frictional engagement members 16 are formed on the body portion 12. These frictional engagement members are configured to frictionally engage a shoulder S or stepped out region within a traffic cone C of the type shown in FIGS. 3A through 3C. In this manner, the illuminating device 10 may be inserted into the top end opening O of a traffic cone C and advanced until the frictional engagement members 16 are beneath the shoulder S of the traffic cone C, thereby retaining the illuminating device 10 at an operative positioned within the top opening O of the traffic cone such that the illuminating device 10 may cast light downwardly into an inner space inboard of the frusto-conical side wall of the traffic cone. All or part of the cone's side wall is translucent, thereby allowing some of the light to pass through the side wall of the cone resulting in a luminescent glow as seen in the photograph included in Appendix A.

Light is emitted from the bottom end of the illuminating device 10. A plurality of light emitting diodes (LEDs) 24 are positioned to cast light through an annular lens 20 mounted on the bottom end of the illuminating device 10. This casts light downwardly within the inner space of the traffic cone C and against the inner surface of the side wall of the cone C.

A hollow channel 22 extends vertically through the illumination device 10. Compressible electrodes (e.g., spring electrodes) 24 are positioned on opposite sides of the hollow channel 22. As described more fully below, these electrodes 24 are useable for charging rechargeable batteries 28 within each illumination device 10 (see FIGS. 3C through 3E).

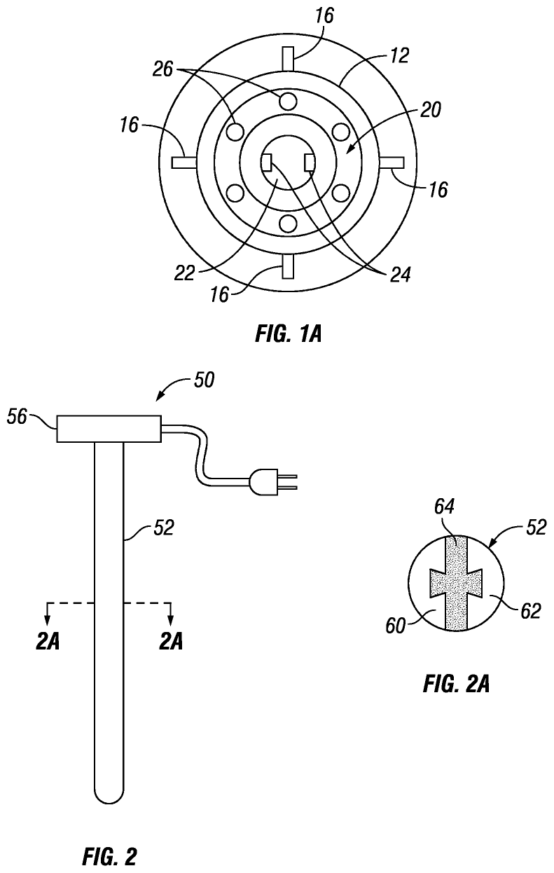

FIGS. 2 and 2A show a charging device 50 that is useable for simultaneously charging a plurality of the illuminating devices 10 while they are attached to traffic cones C which are stacked one atop another, as seen in FIGS. 3B-3C. This charging device 50 comprises an elongate charging member 52 and a top hub 56. As seen in the cross-sectional view of FIG. 2A, the elongate charging member 64 has a positive charging electrode 60 which runs along one side of the elongate charging member 52 and a negative charging electrode 62 which runs along an opposite side of the elongate charging member 52. An electrical insulator 64 is positioned between the positive and negative charging electrodes 60, 62.

The illuminating devices 10 are operatively positioned on the traffic cones C such that, when the traffic cones C are stacked one atop another, the hollow channels 22 of the illuminating devices 10 will be in alignment such that the elongate charging member 52 may be inserted downwardly through the aligned channels 22, thereby causing the charging electrodes 60, 62 of the charging device 50 to make contact with the electrodes 24 of each illuminating device 10. This allows charging energy to be delivered from the charging device 50 to each illuminating device 10, in parallel (see FIGS. 3D and 3E). The charging electrodes 60, 62 and separating insulator 64 of the charging device 50 as well as the corresponding electrodes 24 of the illuminating devices 10 may be sized, configured and positioned in a manner which precludes both of the electrodes 24 on any one of the illuminating devices 10 from simultaneously contacting either the negative charging electrode 60 or the positive charging electrode 62, which would result in a short circuit. Rather, such sizing, configuration and positioning may be such that either a) both electrodes 24 of a particular illuminating device member will contact the insulator 64 or b) one electrode 24 of the illuminating device 10 will contact the positive charging electrode 60 and the other electrode 24 of that illuminating device 10 will contact the negative charging electrode 62. The contactable surface area occupied by the insulator 64 may be substantially less than that of each charging electrode 60, 62 thereby making it unlikely that both electrodes 24 of any one of the illumination devices 10 will contact only the insulator 64. Optionally, one or more contact indicator(s) (e.g., small LEDs) may be mounted on the hub 56 of the charging device 50 and may be wired to indicate whether any or all of the illumination device electrodes 24 are making charging contact with the positive and negative charging electrodes 60, 62, as intended. If such indicator(s) indicate that any of the illumination devices 10 are merely making contact with the insulator 64, the user may then rotate the elongate member 52 slightly until such indicator(s) indicate that all of the illumination device electrodes 24 are making suitable charging contact with the positive and negative charging electrodes 60, 62 of the charging device, as intended.

Optionally the charging system may use inductive electromagnetic transmission of power from one lamp to the other.

The internal illuminating devices 10 disclosed herein, as opposed to use of single-point lamps) can illuminate surfaces of cones or other warning or vehicular channelizing devices such that light may be diffused and/or reflected. This provides for a larger light source to be presented to the driver or pedestrian while using substantially less energy. As battery-powered devices are the norm for temporary and Homeland Security guidance systems, energy conservation resulting in brighter lamps or longer battery life is always sought. This invention aims to use the same energy as a point light source to illuminate a much larger area. Thus, the object illuminated will be more visible to the driver or pedestrian.

The light source(s) used in devices of the present disclosure may be LED, laser, or fluorescent technology directed either upward into the delineator if mounted near the base, or downward when mounted in the top of the delineator. The light source may be inserted inside the delineator or from the outside, either through the surface of through a hole in the delineator and directed inward. The light source may be outside of the delineator and directed in such a sway as to “bathe” the object with a soft light that causes the plastic to glow.

In addition, a device that is designed with proper geometry such that the traffic cone can be stacked upon other traffic cones, or that will allow barrels to be stowed consistent with standard delivery techniques will allow for “standard operating procedures” by the crew deploying the device. The crew will not have to change anything that they do. As they collect the cones or barrels, they will handle them as though there were no light source inside or outside the delineator. In current lighting systems for temporary traffic control delineators, the operator must remove the light from the device before retrieving the delineator. As this occurs each evening, the installation and removal of the light source each day becomes troublesome and potentially dangerous. This is often accomplished once the delineator is deployed on the highway thereby exposing the worker to fast-moving vehicles.

The lamps can be designed to turn on automatically when placed on the road surface or turned on remotely by cloud-based communication or local remote control. Hence, once dropped from a moving truck, for example, hundreds of traffic cones can be turned on by a simple press of a button from the safety of a vehicle 1000 meters away, or from the desktop in a different state or country. The delineators internally lit can be programmed to light in a sequential pattern, reverse pattern, steady-glow pattern, or other desirable combination. They can flash in one of many different patterns or rates—once-per-second, faster, slower, etc. They can sequence from delineator to delineator in the direction of traffic flow, much as a runway landing system, or in the opposite direction.

In addition to generating light, the system can emit sound or radio waves of any frequency or protocol (Bluetooth, 4G, 5G cellular, Wi-Fi, for example) to interface either directly to autonomous vehicles or via cloud up-link and then down-link to the autonomous vehicle to provide Ground Truth pertaining to location of the work zone and geometry of the work area. The sensors in the cone that synchronize and coordinate flashing between cones can also pass vehicle count, speed, temperature, impact/motion or other monitored parameter to a cloud-based system via a local (lamp-based) network system with a single or multiple cellular connection to the cloud.

With the IoT sensor, including accelerometer or other tilt sensor, the internally illuminated delineator can act as a warning bringing notification to workers of a vehicle intrusion into the work zone or pedestrian area. Should a vehicle enter a sector where pedestrians are working or congregating and the delineators are positioned where they must be struck to enter this area, an accelerometer would register the impact and send a radio signal or sound signal or light signal to warn workers or pedestrians that a vehicle has entered a protected area. As the sensor would be located on the circuit board of the light synchronizing network device, it is permanently installed in the cone or barrel or delineator and does not represent an “add on”. Hence, it is always part of the standard deployment of standard delineators, unlike dedicated intrusion systems. This represents an advance in the technology that lowers the cost and eases deployment of this safety system.

To be operationally desirable and used without reluctance, the batteries powering the lamps can be rechargeable, although non-rechargeable energy sources may be used. Solar panels built into the top of the traffic barrel or wrapped around the traffic cone (flexible solar panels are available) can be used to harvest solar energy.

Sound energy available in great wattage on the roadway can be captured and harvested using piezo or other technology to charge batteries.

Wind energy can be used, both generated naturally and by vehicles passing by, to spin a small propeller, turbine, or flapper to capture energy for charging.

An alternative to charging on the roadway is to have stackable delineators, such as traffic cones with the lamps permanently installed, conduct electricity from stacked cone to the stacked cone below it. For example, 10 cones can be stacked with each making electrical connection to charge the one below it. In this way a charging system, plugged into the wall mains power or 12-24 v vehicle system, can be placed atop the upper most cone. The electrical charging power would be delivered to each cone by virtue of electrical contacts built into the permanently installed lamp such that each lamp-battery system receives charging current from the one above or below. FIG. 1

An alternative charging system is by way of a “wand”, a long, electrically conductive rod that would be temporarily passed down the middle of each lamp that has been inserted permanently into the top of the cone. The wand would contact each of the lamps inside the stacked cones and bring electrical charging current in “parallel” rather than in “series” as described above. This system will avoid the necessary spring contacts and precise spacing and geometry required to have 10 lamps contact each other in a precise geometric way. Either charging system is specifically designed to allow for random stacking of the delineator; that is, the orientation of the cone, for example, can be stacked in any 360-degree position. Stated alternatively, the cones need not be stacked in a particular pattern or lined up in a specific way.

Optionally, the illuminating devices 10 may incorporate radiofrequency or other communication systems and may be equipped to be controlled and to communicate and/or self-synchronize with one another using a flocking protocol, mesh network or any other circuitry, apparatus, function, format, sequence, flashing program or other operation described in any of the following United States patents: U.S. Pat. No. 8,564,456 entitled Sequenced vehicular traffic guiding system; U.S. Pat. No. 8,154,424 entitled Sequenced Vehicular Traffic Guiding System; U.S. Pat. No. 9,288,088 entitled Synchronizing the Behavior of Discrete Digital Devices; U.S. Pat. No. 9,847,037 entitled Sequenced Guiding Systems for Vehicles and Pedestrians; U.S. Pat. No. 9,835,319 entitled Sequential and Coordinated Flashing of Electronic Roadside Flares with Active Energy Conservation; U.S. Pat. No. 10,443,828 entitled Sequential and Coordinated Flashing of Electronic Roadside Flares with Active Energy Conservation; U.S. Pat. No. 10,536,519 entitled Synchronizing the Behavior of Discrete Digital Devices and U.S. Pat. No. 10,660,183 entitled Devices and Methods for Synchronized Signaling of the Positions of Moving Pedestrians or Vehicles, the entire disclosure of each such patent being expressly incorporated herein by reference.

Optionally, as explained more fully below, the illuminating devices 10 may incorporate sensors and/or transmission apparatus for sensing and/or transmitting data which relates to the illumination devices 10, the traffic channelizing/marking devices (e.g. traffic cones C) to which the illumination devices 10 are attached, and/or areas near such devices, such as, for example, data which indicates: the device being impacted, the device being knocked over; incursion of a vehicle into a zone marked by the device, temperature and/or other weather conditions at the location of the device; wind velocity and/or direction at the location of the device; speed of vehicles traveling past the device; size or weight of vehicles traveling past the device; charge status of a power source (e.g., batteries 28) that powers the device and functioning or current functional status of the device.

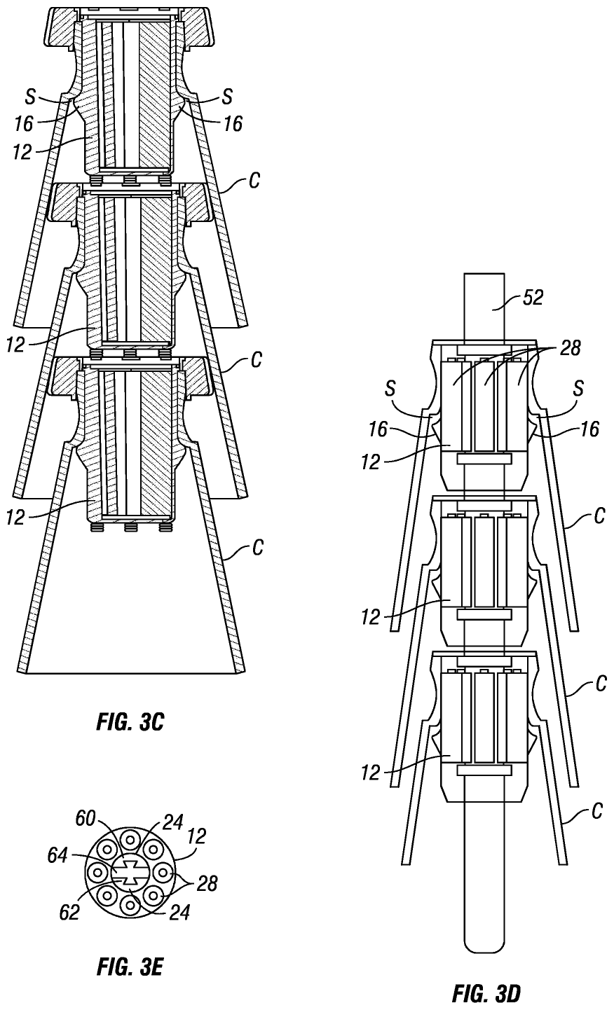

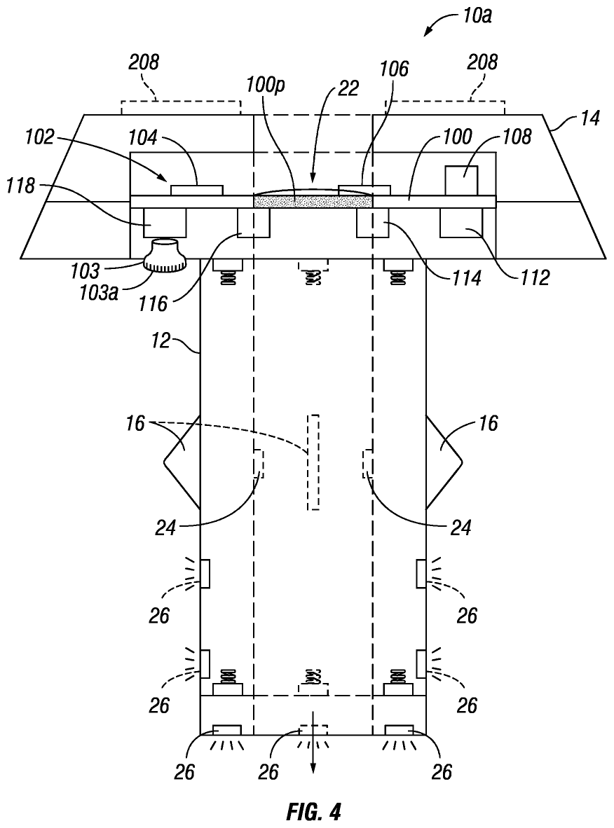

FIG. 4 shows an alternative embodiment on the illumination device 10a which includes the elements of the device 10 shown in FIG. 4, as well as additional elements to perform some or all of the above-summarized additional functionality. In the example of FIG. 4, the illuminating device 10a includes either a node circuit board 100 (shown within the illuminating device in FIG. 4) or a gateway circuit board 200 (shown separately in FIG. 5), mounted within an internal cavity 102. Either circuit board 100 or 200 may have a toroidal shape or other configuration that includes a central aperture which aligns with the hollow channel 22 through which the charging device 50 is insertable.

Components mounted on the node circuit board 100 (shown FIG. 4) may include any or all of: a GPS antenna 104 (GGBLA.125.A, Taoglas USA, San Diego, Calif.), GPS GNSS receiver 106 (GGBLA.125.A, Taoglas USA, San Diego, Calif.), MCU transceiver 108 (CC2530F256RHAR, Texas Instruments, Dallas, Tex.), accelerometer 110 (LIS2DH12TR, ST Micro, Geneva, Switzerland), voltage regulator 112 (UM1460S-33, Union Semiconductor, Hong Kong, China), LED driver 114 (BCR421, Diodes Incorporated, Plano, Tex.), temperature sensor 116 (HTS221TR, ST Micro, Geneva, Switzerland) and humidity sensor 118 ((HTS221TR, ST Micro, Geneva, Switzerland). A vent 103 with weather protection filter 103a may be formed through the wall of the cavity 102, as shown, to permit circulation of ambient air into the cavity so that any temperature sensor 116 and/or humidity sensor 118 to accurately sense temperature and/or humidity in the area of the device 10a. The listed components, when present, may perform at least the following functions:
GPS antenna 104 and GPS GNSS receiver 106 enable a node or gateway device to send and receive Ground Truth data and/or other information by GPS. Examples of the types of information that may be received and/or transmitted using the GPS antenna 202 GPS GNSS receiver include the precise location of the device (e.g., longitude/latitude) and incorporated in the satellite-based GPS GNSS signal, may be precise timing information which can be used to synchronize the mesh network radio transmission/receiving timing using less power than low duty cycle synchronization. Absent the precise GPS GNSS timing information, the nodes in the mesh network must “awaken” periodically, for example, every 100 milliseconds, to connect with other nodes to reset their clocks. Otherwise, internal MCU clocks may drift. With the external clock reference available with GPS GNSS, the duty cycle used to resynchronize can be much lower. The nodes my awaken every 30 seconds, for example. Hence, GPS GNSS circuitry provides not only location information but timing and mesh synchronization as well.
MCU transceiver 108 enables wireless radiofrequency transmission to and from a node or gateway device in which it is positioned. Examples of the types of information that may be received and/or transmitted using the MCU transceiver 108 include information for sequencing or controlling operation of networked devices as described in the various United States patents and published United States patent applications referred to above and expressly incorporated herein by reference, as well as sending information relating to the status and/or functioning of individual networked node devices to or from a gateway device which, in turn, may send/receive information (e.g., GPS location, accelerometer-sensed movement and orientation relative to gravity, sensed temperature, sensed humidity, LED operating mode/pattern/status, software firmware updates, or other communication to one or more remote locations (e.g., control centers) via telephonic, fiber optic cable (when available), internet, cloud-based, cellular, direct to vehicle, or other means, etc.;
accelerometer 110 senses movement of any device in which it is positioned and enables movement-related information (such as notification that the device has been impacted by a vehicle, tipped over by wind, or otherwise moved from its intended position or location;
voltage regulator 112 provides voltage regulation;
LED driver 114 drives and controls LEDs such as LEDs 24, 26 and/or 310 described in the above examples;
temperature sensor 116 senses ambient temperature; and
humidity sensor 118 senses ambient humidity.

Components mounted on the gateway circuit board 200 (FIG. 5) may include any or all of the components shown on the node circuit board 100 (FIG. 4) and, in addition, any or all of the following additional components: cellular antenna 202 (FXUB63070150C, Taoglas, San Diego, Calif.), cellular modem 204 (B402, Particle, San Francisco, Calif.), and solar harvester/charging circuit 206 (SVT1040, ST Micro, Geneva, Switzerland or BQ25505, Texas Instruments, Dallas, Tex.). These additional components, when present, may perform at least the following functions:
The cellular antenna 202 and cellular modem 204 enable cellular communication to and from a gateway device in which the gateway circuit board 200 is present. Examples of the types of information that may be received and/or transmitted using the cellular antenna 202 and cellular modem 204 include sending/receiving information via cellular or other communication to one or more remote locations (e.g., control centers) via telephonic, internet, cloud-based or other means, etc.
In at least some areas, fiber-optic communication networks may be available near roadways (e.g., sometimes provided by infrastructure providers such as governmental Departments of Transportation or other authorities). Access to such fiber-optic networks may this be obtained (e.g., using junction boxes located along highways). Where in range of a work zone, the gateway 200 circuit board, could be equipped to plug directly into the fiber optic cable system to avoid cellular modem hardware cost and recurring monthly connection and server fees.
The solar harvester/charging circuit 206 provides integrated energy management by extracting power from any properly connected solar panel (e.g., 208 or 305 described below) and using such energy to charge one or more batteries (e.g., 28 or B).

In embodiments where a gateway circuit board 200 which includes a solar harvester/charging circuit 206 is mounted in the illumination device 10a shown in FIG. 4, the illumination device 10a may further include an optional solar panel 208 and associated circuitry connecting that solar panel 208 to the solar harvester/charging circuit 206. If mounted on top of the device 10a as shown in FIG. 4, the optional solar panel 208 may have a toroidal shape or other configuration which includes a central aperture which aligns with the hollow channel 22 through which the charging device 50 is insertable.

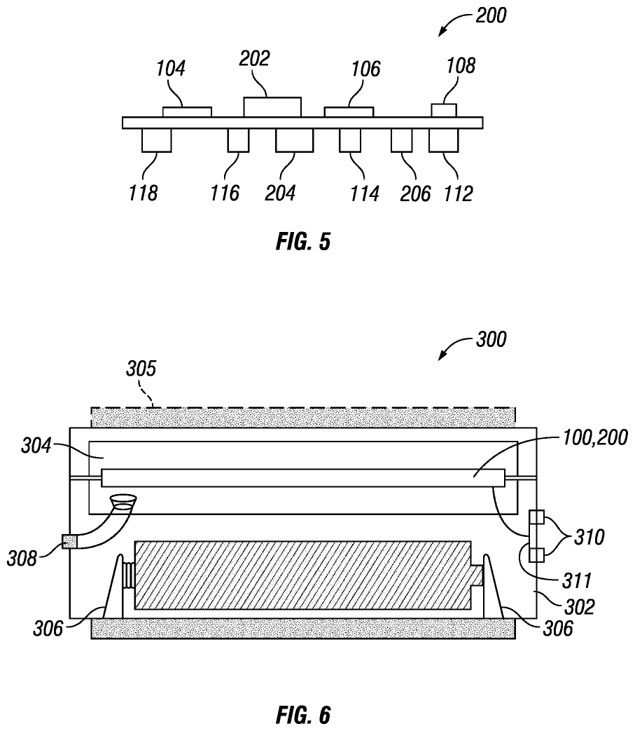

FIG. 6 shows one non-limiting example of a housing device 300 within which either the node circuit board 100 or gateway circuit board 200 may be mounted. This housing 300 may then be attached to or positioned on any suitable type of traffic channelizing device (e.g., cone, delineator, barrel, fencing, flare, warning light, sign, electronic roadside display, etc.) or any other object (vehicle, construction equipment, roadway debris, etc.). In the example shown, this housing 300 comprises an enclosure having an inner cavity 304 within which the circuit board 100 or 200 is mounted. Battery contacts 306 are provided such that a battery may be mounted within the housing device 300 to power the device. In embodiments where the circuit board 100 or 200 includes a solar harverster and charging circuit 206, the housing device 300 may also include a solar panel 305 and associated circuitry to collect and use solar energy to power the device and/or change the battery B. In embodiments where the circuit board 100 or 200 includes temperature and/or humidity sensor(s) 116 and/or 118 a vent 308, which may include a weather protection filter and/or associated duct(s) may be provided to permit circulation of ambient air into the cavity 304 so that any temperature sensor 116 and/or humidity sensor 118 may accurately sense temperature and/or humidity in the area of the housing device 300.

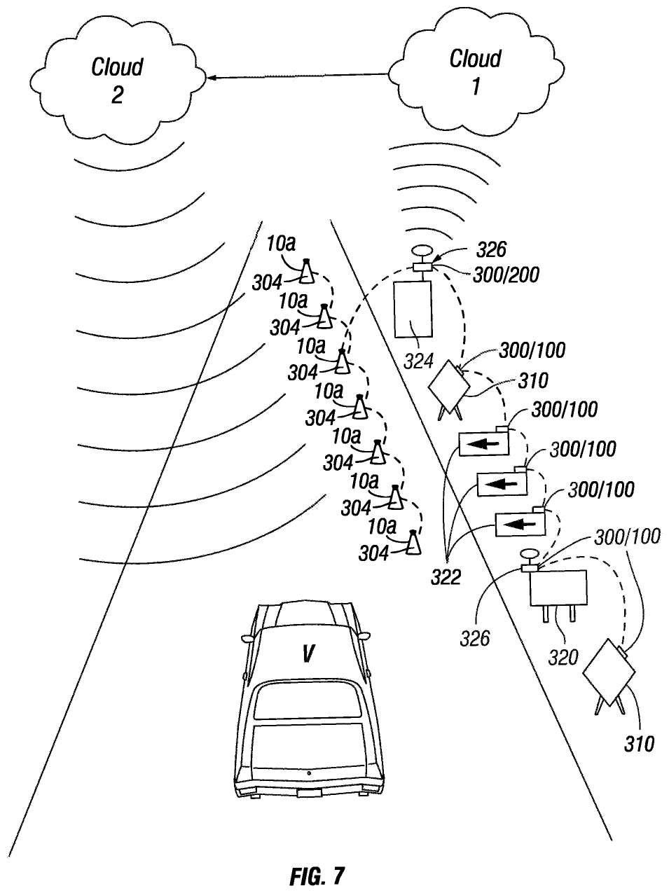

Also, as shown in FIG. 6, the housing device 300 or the above described illuminating devices 10 or 10a or any other device operable in accordance with this disclosure, may include infrared or visible LED's 310 with an associated driver, LED circuit board or module, to emit infrared or visible light. As explained more fully below, in some embodiments, infrared and/or visible light emitted from such LEDs 310 may be received directly by sensors and/or cameras on oncoming vehicles that are equipped with electronic driver warning/assist, autopilot or autonomous control systems thereby enabling the electronic driver warning/assist, autopilot or autonomous control systems of such vehicles to issue warning or control actions to evade or prevent collision with the device 10, 10a, 300 from which the LED infrared or visible light emanates. In one embodiment, circuit board 100 or circuit board 200 (node or gateway), or their components, could be mounted and enclosed in an operating lamp such as 326 in FIG. 7 (below) or any other work zone device. This lamp or other device would then act both as a warning or safety device and a communication link to other nodes 300/100 or as the gateway to Cloud 1 (300/200).

FIG. 7 shows one non-limiting example of a smart highway work zone comprising a network of devices of the type described in this disclosure. Illumination devices 10a (FIG. 4) are mounted on traffic cones 304. As shown, these cones 304 are positioned in a row on a roadway surface to delineate a narrowing area of travel, such as a partial lane closure. Each of the cone-mounted illumination devices 10a is equipped with a node circuit board 100. This smart work zone network also includes a number of additional items positioned along one side of the roadway, as follows:
A plurality of diamond shaped portable warning signs 310 having housings 300 attached thereto, each such housing being equipped with a node circuit board 100 as described above;
A rectangular post-mounted sign(for example, a barricade) 320 which has a flashing warning light 326 mounted thereon with an attached housing 300 equipped with the node circuit board 100 as described above;
A series of electronic displays 322 programmed to show illuminated arrows directing traffic to move to the left, with attached housings 300 equipped with the node circuit board 100 as described above; and
A reflective traffic barrel 324 having a flashing warning light 326 mounted thereon with a housing 300 equipped with the gateway circuit board 200 attached thereto.

In the example of FIG. 7, an operator of the oncoming vehicle may, at minimum, perceive visible light being cast trough the traffic cones 304, or a barrel 324, and from the illuminated signs 300 and may visualize other aspects of the various signs and objects as they come within view. However, beyond such direct line-of-sight visualization by a vehicle operator, the various devices shown in FIG. 7 may provide additional information to vehicles V which are equipped with GPS (GNSS), infrared sensors, cameras, autopilot and/or autonomous control capabilities. For example, vehicles or vehicle occupants who have GPS navigation system(s) or access to internet-based GPS information may receive information from the work zone shown in FIG. 7 before coming within visualization distance of the work zone. The work zone devices, 100 and 200, may communicate directly with the vehicle V via radio communication to deliver their data, or multiple devices 100 can transmit their Ground Truth data (location, temperature, humidity, orientation to gravity, etc.) to the gateway 200 mounted atop barrel 324 in enclosure 300. Gateway 200 will then transmit the collection of data provided by all devices 100 (and sensors in 200 as well) to Cloud 1. This may occur by cellular communication or, as noted above, by direct fiber-optic connection if such connection is available.

Processing and re-transmission of these data in Cloud 1 will be followed, in real time, by transmission to the internet and to Cloud 2. From Cloud 2 specific data, such as location, asset type (barrel, barricade, concrete barrier, sign, message board) will be delivered via cellular connectivity to the vehicle for on-board processing (autonomous vehicles) and display on the user interface in the dashboard of the vehicle V. In such fiber-optic connected embodiments, nodes 10a and 300/100 will continue to communicate with gateway 300/200 but the gateway 300/200 may use the fiber optic network, rather than cellular connectivity) to connect to Cloud 1.

For example, as shown, cone-mounted illuminating devices 10a may transmit and receive information from one another. If at least a single node 300/100 is located within radiofrequency transmission range of the gateway device 300/200 mounted on barrel 324, then this single node (or multiple nodes 300/100) will act as a conduit to transmit the entire network's data collection, or control commands, to and from the gateway 300/200. There may be multiple routes (e.g., paths) for information acquired in 10a or 300/100 devices to come within range of 300/200 where these data will be transmitted to, or received from, gateway device 300/200. When new data is sent via the mesh network to gateway 300/200, or when failure of receipt of information is detected (e.g., scheduled periodic health status check), gateway 300/200 will transmit such information by cellular connection or fiber optic cable to first data-receiving location (e.g., a data center or control center operated by a proprietor of the system) in Cloud 1. Such information may include status information for each node device such as battery charge status, operational status, accelerometer impact status etc. Such information may then be used to dispatch any appropriate service personnel to deal with any needed maintenance issues such as battery recharging, repositioning/repair of impacted or moved devices, or devices blown over by wind or truck wake, replacement of non-functioning devices, etc.

Cloud 1 may also transmit some or all of the information to one or more second data receiver(s) (e.g., police, governmental transportation department, a subscription based in-vehicle information system such as General Motors OnSTar™ system, HERE Technologies, or other data receiver). That second data receiver may then utilize the information that it receives for various purposes and/or may re-transmit some or all such information to the vehicle or to other locations. In some instances, the second data receiver may transmit some or all of the information to a receiver located in the vehicle V and apparatus within the vehicle may then process the received information to cause it to appear on a navigation monitor or GPS-enabled map, and/or may issue audible, visual, tactile or other warning(s) to an operator of the vehicle based on the received information. For example, a navigation monitor or GPS map in the vehicle V may display an indication (e.g., a visible line or marking) of the location of the work zone as well as other information such as an indication of “left lane close” or the like. If the receiving vehicle is equipped with an autopilot, driver-assist system or autonomous control.

Also, control signals may be sent via Cloud 1 to the gateway device 300/200 mounted on barrel 324 which, in turn, may transmit such control signals via radiofrequency transmission to all of the node devices in the network. In this manner, a control center may remotely transmit to all of the node devices any desired setting changes (e.g., changes in LED flashing frequency, pattern, sequence or color, accelerometer sensitivity, turn device on or off), software/firmware updates, etc.

Another aspect of the many-to-one nature of mesh network to single gateway illustrated in the Example of FIG. 7 is the ability for control of work zone assets. When work is completed for the day, various warning lamps are to be turned off. Drivers must slow when work is underway but may return to posted speeds when personnel are not present. To turn off specific lamps placed in lanes that are closed personnel must subject themselves to danger of on-coming traffic. Personnel in a main office, often in a different county or state can now remotely control all of the lamps flashing in the work zone from the safety of their desktop computer. A control command such as “turn off lamp 326” sent from the internet dashboard opened on a computer in one city or state, for example, could control a flashing warning lamp in another city or state. Personnel would not be placed in danger, and drivers would not be subjected to unnecessary delays in transit by an inappropriately flashing lamp when the work zone is non-operational or personnel are not present.

In an event where a traffic cone 304 is struck by vehicle V and displaced into the roadway, the impact will be sensed by device 10a, which will cause the device 10a to wake within milliseconds from its quiescent low-power state. It will then immediately transmit an impact alert. If the next neighboring traffic cone 304 in the row is not in receive mode at that precise time, the transmitted impact alert may nonetheless be received by another networked device, such as device 300/100 mounted on the lamp 326 affixed to barricade 320. In either case, the impacted-cone associated-device 300/100 will continue to transmit the impact alert until it receives a confirmation acknowledgement from any other device in the network. The devices may be set to listen at spaced apart time intervals, e.g., every 100 milliseconds, for example. This impact alert will then be transmitted from node to node (device 300/100 to device 300/100) whether atop a traffic cone, barricade, barrel, sign, etc., until the alert is delivered to gateway 300/200 mounted on lamp 326. This event will then be transmitted from gateway device gateway 300/200 to Cloud 1, which will then re-transmit the alert to Cloud 2. Vehicles (V) equipped with cellular connectivity headed in the direction of the work zone and within a pre-defined distance (Geofence, for example, 3 kilometers and approaching) will receive the alert from Cloud 2. On a suitable map display, for example a dashboard display, the map will change to indicate an “object in the roadway” at that precise location. In addition, onboard computers in the vehicle V may be provided with data to enable evasive maneuvers by the vehicle V or corrective maneuvers may be implemented or prompted the vehicle's driver assist and/or autonomous control systems. At the same time, an alert (e.g., electronic text message, email, or audible alert) may be sent to maintenance crews or contractor personnel to inform them of the displaced cone or “object within the roadway” at designated location, thereby enabling prompt corrective measures to be taken.

Another example is where an autonomous or other automated control vehicle V is aided by the system when it approaches within a certain range (e.g., 3 kilometers) of the work zone. The traffic cone 304 (or other delineator so equipped with sensor 300/100 or 10a) provides GPS GNSS location data. These bits of location data are constantly sent, via the mesh network to gateway 300/200, which forwards these data, via fiber optic or cellular connectivity, to Cloud 1. The latitude and longitude data points are then transmitted to Cloud 2 and then from Cloud 2 to the approaching vehicle V within 3 kilometers of the work zone position. On board computers in the vehicle V may then draw a virtual line connecting these objects, thereby creating a “hard” virtual barrier and may cause the vehicle to navigate in a manner that does not cross or encroach too closely to the virtual line. This provides a safe work zone wherein personnel are protected by real time Ground Truth data.

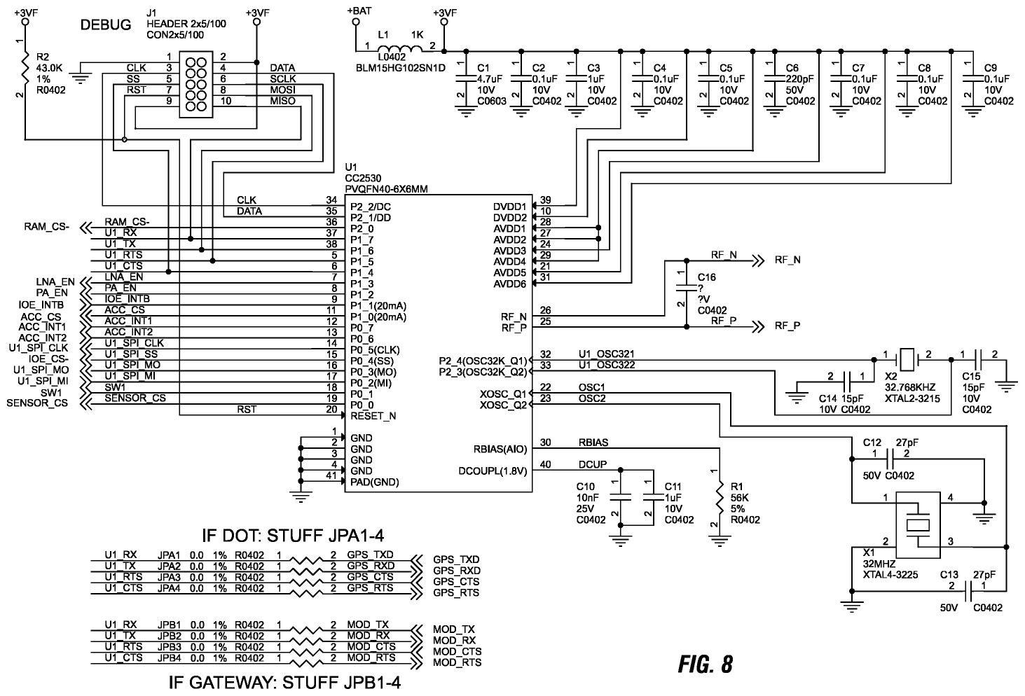

FIGS. 8 through 16 show examples of the electronic circuitry designed to monitor and control the devices described in this disclosure.

FIG. 8 shows a circuit referred to as the “RF Engine, which comprises a Texas Instrument CC2530 microcontroller (U1) and 2.4 GHz radio transceiver in a single System on a Chip (SoC). This circuit incorporates an 8051-series microcontroller. The MCU is programmed via the J1 header using a 10-pin connector. Two crystals are utilized; X1 is a 32-megahertz crystal for timing radio communication while X2 32.768-kilohertz controls the Watch Dog Time when the device is in low-power sleep mode.

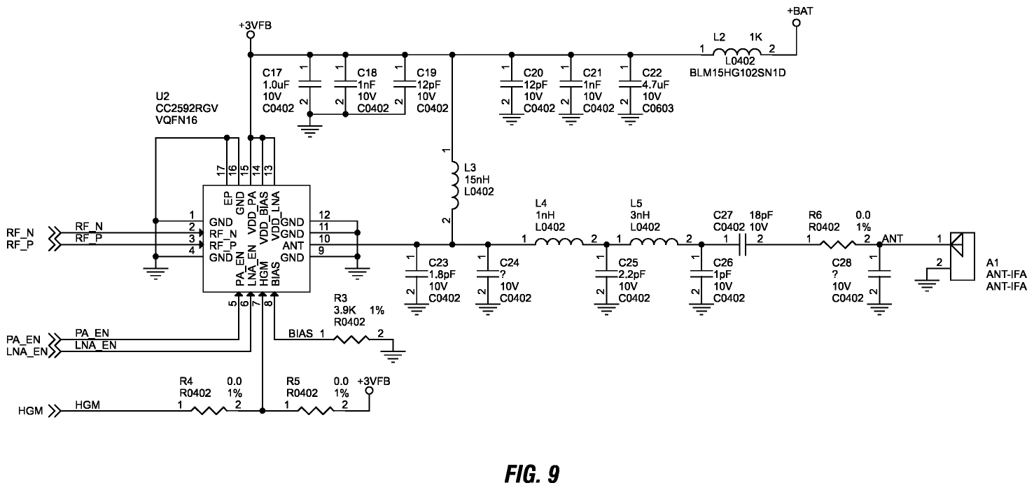

FIG. 9 illustrates the design of the radio frequency range extender (U2). The CC2530 MCU described in FIG. 8 can drive an inverted-F trace antenna directly. However, for greater radio range, the addition of the CC2592 (Texas Instrument) range extender amplifies the radio frequency output signal of the CC2530. It uses the Pi network illustrated by the capacitors and inductors on the ANT output, and drives the trace inverted-F antenna at 50-ohm impedance resonant at 2.45 GHz.

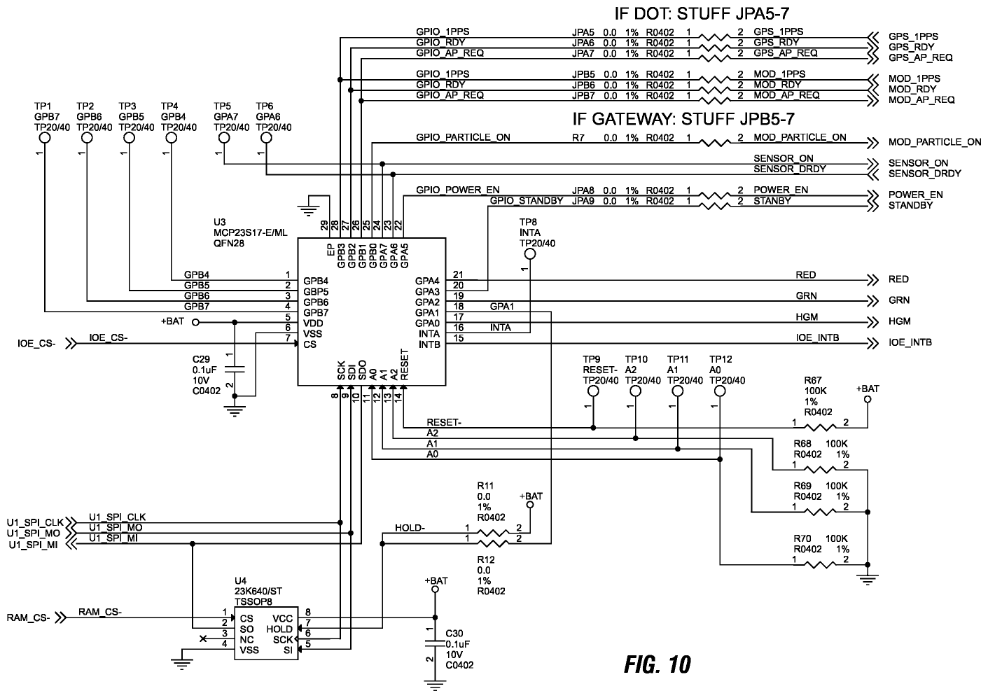

FIG. 10 defines the circuitry for U3 and U4. U3 an input-output expander (I/O expander) incorporated to provide more controls features. The CC2530 MCU SoC has limited inputs and outputs 21 inputs and outputs. With the addition of temperature sensing, GPS GNSS, accelerometer, cellular communication, etc., additional I/Os are required. This MCP23S17 (Microchip Corporation) provides 16 additional external controls. U4, part number 23K640 (Microchip Corporation) provides addition memory required for collecting, transmitting, and storing data. This component, external RAM, also provides the necessary memory to do Over the Air (OTA) updates to the CC2530 and the associated components. An SPI bus is used to communicate to components U3 and U4.

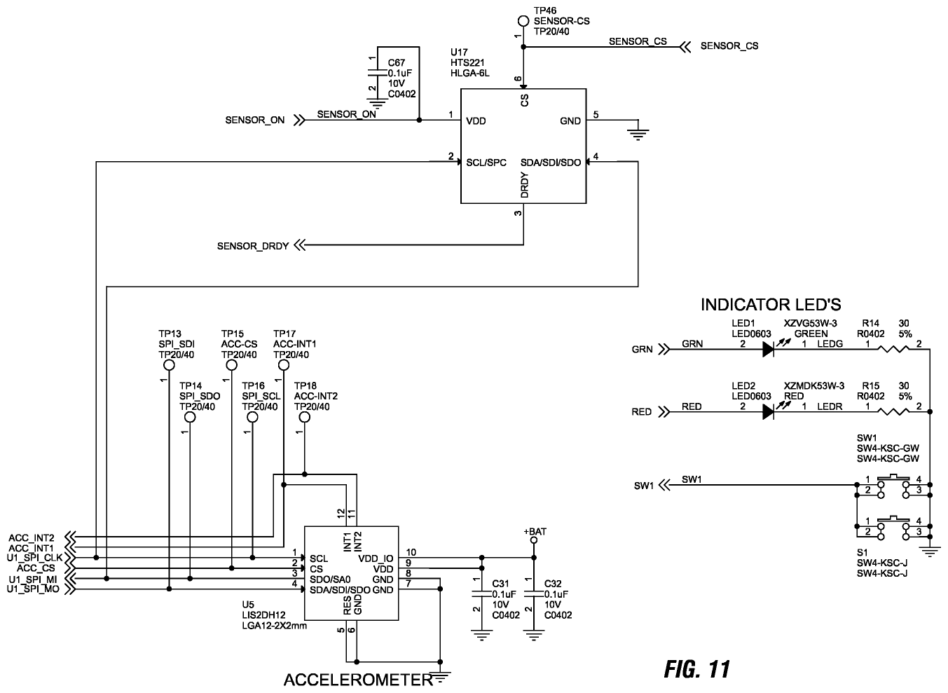

FIG. 11 shows circuitry for temperature, humidity, and acceleration (impact) sensors utilizing components U17 and U5, as shown in FIG. 11. These also communicate to the MCU U1 via an SPI communication bus. U17, sensing temperature and humidity (ST Microelectronic), requires a weather protected vent to the atmosphere outside the sealed enclosure. The accelerometer (LIS2DH12) U5 (ST Microelectronics) can be remotely adjusted to tune sensitivity. Low power indicator LEDs, LED1 and LED2, are used for validation and testing during production.

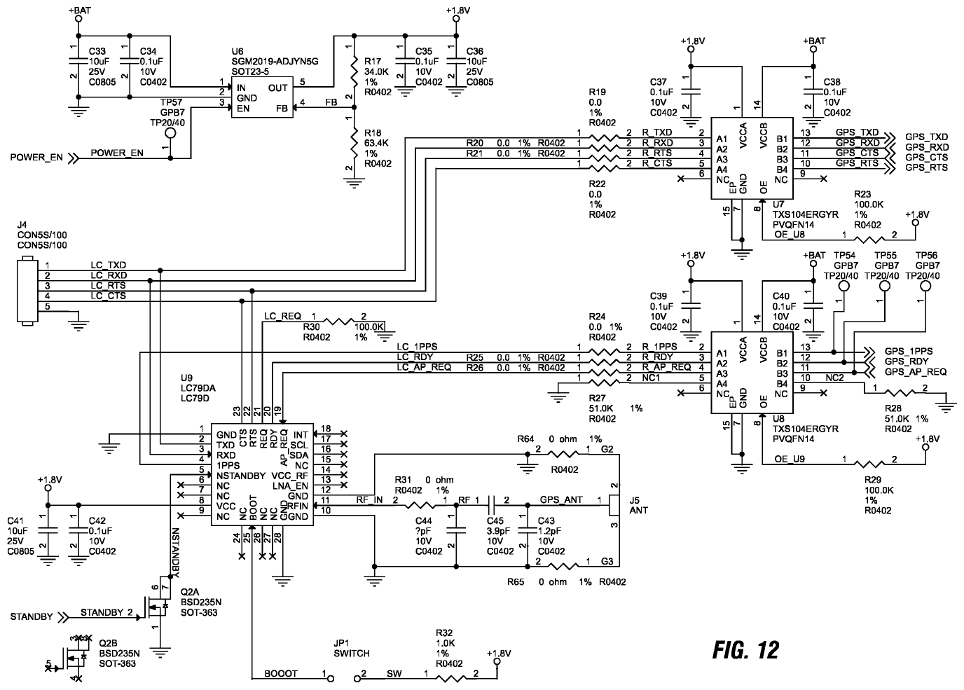

FIG. 12 shows U9, the GPS GNSS system (LC79DA—Quectel), which communicates via UART protocol. It requires a separate power regulator U6 (SGM2019) at 1.8 volts. As the MCU operates at 3.3 volts, level translation is required for I/Os and is accomplished with U7 and U8, Texas Instruments TXS104.

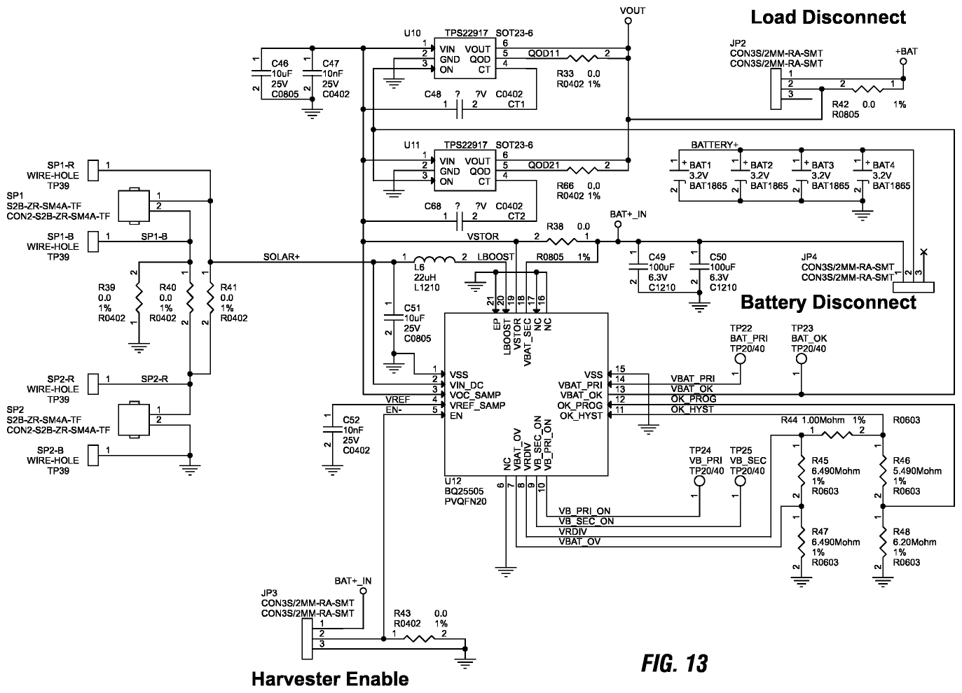

FIG. 13 shows a solar harvester, BQ25505 U12 (Texas Instruments) which converts low-power input from solar panels (photovoltaic panels SP1 and SP2—optional) and charges the lithium ion or lithium iron phosphate battery. U10 and U11 are switches that disconnect the load should the battery discharge and require several hours of sun to recharge. This allows for faster recharging without the load drawing power.

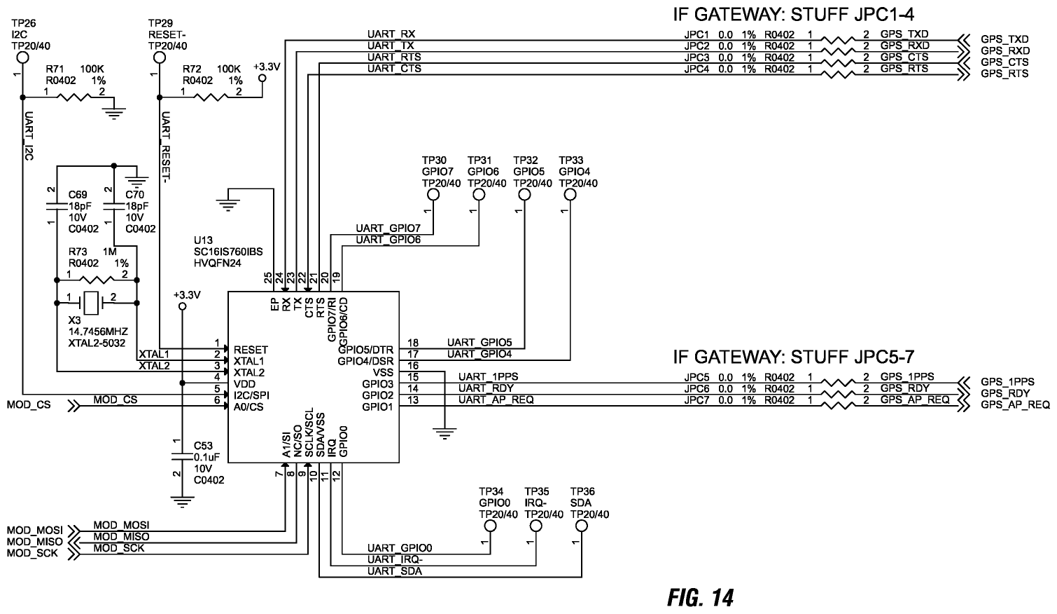

FIG. 14 shows the GPS GNSS and Particle modem in communication with the MCU using UART protocol, a serial translator (U13) translates SPI to UART. U13, SC161S760IBS (NXP Inc.).

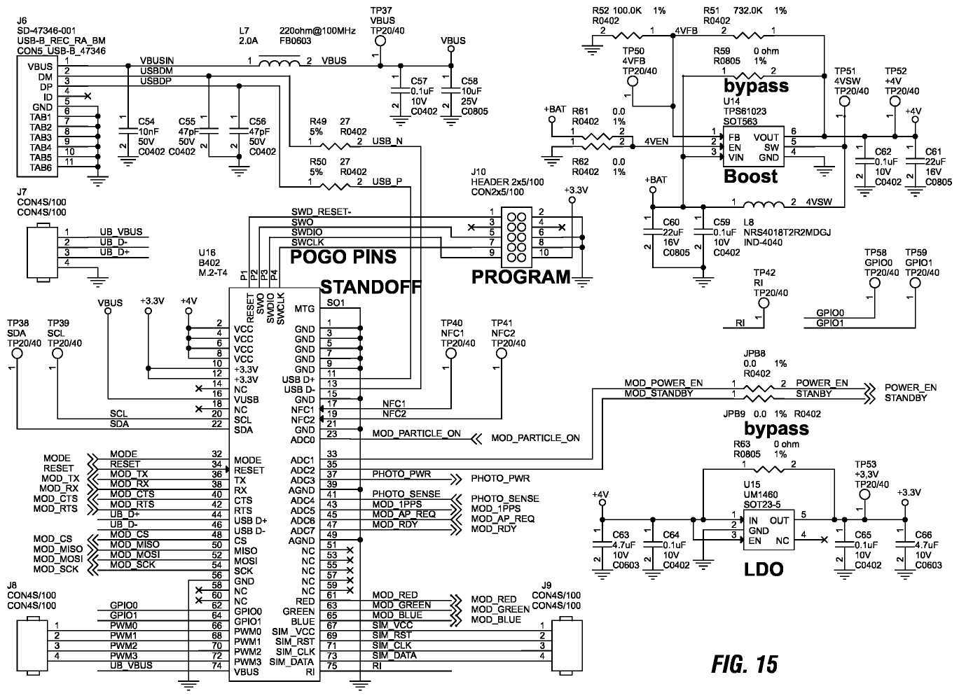

FIG. 15 shows a cellular modem. While communication in this mesh network is many-to-one, the one device connecting via cellular to the cloud requires a cellular modem, which is illustrated in FIG. 15. U16 is a plug-in header for the Particle modem. U14 (Texas Instrument TPS61023) is a boost voltage regulator to supply 4 volts to the Particle modem. This modem also requires 3.3 volts that is switchable (to turn off and lower power consumption when not in use). U15, a Union Semiconductor Low Drop Out regulator (LDO—UM1460) provides 3.3 volts to the Particle to control logic on the modem.

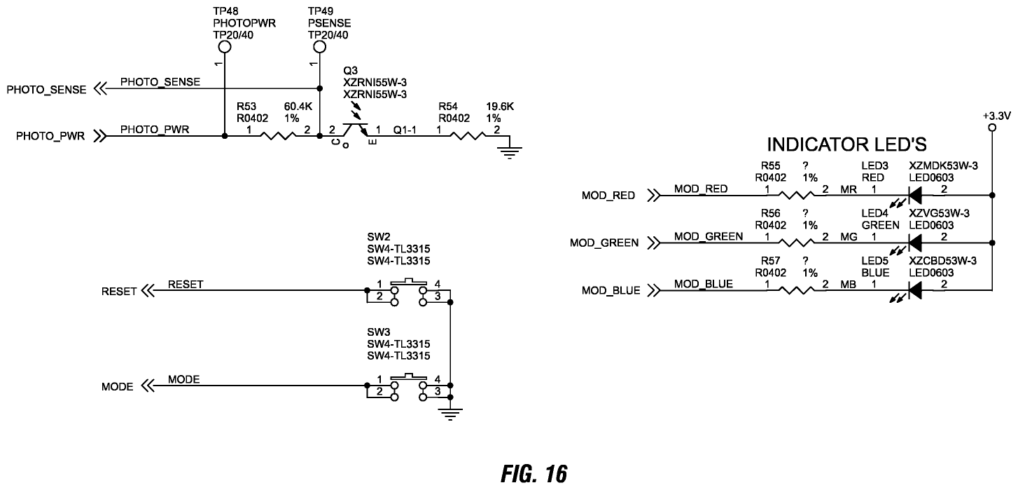

FIG. 16 describes tactile switches, indicator LEDs, and photo sensing circuitry (Q3) These components are used during assembly and final testing of the circuit board prior to production and insertion into the sealed enclosure.

It is to be understood that, as used herein, references to a “vehicle” or “vehicles” is not limited only to land vehicles, but rather also includes boats and other watercraft and the terms “road” shall be construed to include routes or areas traveled by boats and watercraft. Wherever feasible, any of the devices or systems described herein may be placed on a pier, jetty, shoreline, buoy, barge or other flotation device and may be employed to assist boats or watercraft in navigation, harbor entry/guidance and/or avoidance of bridge abutments, obstacles or permanent or temporary hazards. Also, where feasible, signals emitted by the signal emitters may be visible using Infrared night vision goggles, such as those used by the military personnel.

Although the invention has been described hereabove with reference to certain examples or embodiments of the invention, various additions, deletions, alterations and modifications may be made to those described examples and embodiments without departing from the intended spirit and scope of the invention. For example, any elements, steps, members, components, compositions, reactants, parts or portions of one embodiment or example may be incorporated into or used with another embodiment or example, unless otherwise specified or unless doing so would render that embodiment or example unsuitable for its intended use. Also, where the steps of a method or process have been described or listed in a particular order, the order of such steps may be changed unless otherwise specified or unless doing so would render the method or process unsuitable for its intended purpose. Additionally, the elements, steps, members, components, compositions, reactants, parts or portions of any invention or example described herein may optionally exist or be utilized in the absence or substantial absence of any other element, step, member, component, composition, reactant, part or portion unless otherwise noted. All reasonable additions, deletions, modifications and alterations are to be considered equivalents of the described examples and embodiments and are to be included within the scope of the following claims.

1. A system comprising:
a plurality of node devices positionable on or near a roadway or path of vehicular travel, each device comprising electronic circuitry configured to cause said plurality of node devices to communicate as a mesh network; and
a gateway device configured for wired or wireless communication with a remote-control center or data receiver;
said gateway device being further configured to receive data from said node devices and to transmit said data or information based on said data to the remotely located control center or data receiver.

2. A system according to claim 1 wherein the gateway device further comprises a lamp or other signal emitter and functions both as the gateway device and as one of the node devices of the mesh network.

3. A system according to claim 1 wherein the node devices further comprise lamps or signal emitters that emit visible or infrared light.

4. A system according to claim 3 wherein the mesh network communication causes the lamps or signal emitters of the node devices to emit flashes of visible or infrared light in a preset pattern or order.

5. A system according to claim 1 wherein the electronic circuitry of each node device comprises a GPS antenna, GPS GNSS receiver, MCU transceiver, accelerometer or tilt sensor, voltage regulator, LED driver, temperature sensor and humidity sensor.

6. A system according to claim 5 wherein, in addition to apparatus for cellular or fiber-optic communication, the gateway device further includes one or more additional component selected from: a GPS antenna, GPS GNSS receiver, MCU transceiver; accelerometer or tilt sensor, voltage regulator, LED driver, temperature sensor and humidity sensor.

7. A system according to claim 1 wherein the node devices are configured to detect, and the gateway device is configured to in turn notify the control center or data receiver of, of the occurrence of an event selected from:
a change in the location of a node device;
a change in functional status of a node device;
a malfunction or cessation of function of a node device; and
a movement or tilting of a node device.

8. A system according to claim 1 node devices are configured to monitor, and the gateway device is configured to in turn notify the control center or data receiver of, information selected from:
on/off status of a node device;
battery charge status of a node device;
weather at the location of a node device; and
temperature at the location of a node device.

9. A system according to claim 1 wherein the gateway device is configured to receive from a remote location, and to intern transmit to the node devices; at least one type of signal or data to cause the node devices to perform a function selected from:
turn the node devices from off to on;
turn the node devices from on to off; and
cause the a change in the type, color, order, program, timing, pattern or other characteristic of visible or other signals emitted by the node devices.

10. A system according to claim 1 wherein the gateway device is configured to receive from a remote location and to, in turn, transmit to the node devices a software or firmware update.

11. A system according to claim 1 in combination with said control center or data receiver which receives the data transmitted from the gateway device.

12. A system according to claim 11 wherein either:
a) the control center or data receiver transmits some or all of the data that it receives from the gateway device to vehicles equipped to receive such data; or
b) the control center or data receiver transmits some or all of the data it receives from the gateway device to a second control center or data receiver which, in turn, transmits some or all of that data to vehicles equipped to receive such data.

13. A system according to claim 12 wherein data is received or processed only by vehicles within a predetermined distance of the networked node devices.

14. A system according to claim 12 wherein data is transmitted to a vehicle equipped with a GPS map display and wherein the data causes a warning, symbol, indicator, code or mark to appear on the GPS map display.

15. A system according to claim 12 wherein the data is transmitted to a vehicle equipped with an autopilot or autonomous control system and wherein the data causes the autopilot or autonomous control system to cause the vehicle to reduce speed and/or navigate around an object or area.

16. A system according to claim 12 wherein the data is transmitted to a vehicle equipped with an automated driver assist system and wherein the data causes the automated driver assist system to issue a visual, audible or tactile notification or warning to a driver of the vehicle.

17. (canceled)

18. A system according to claim 1 wherein at least one of the node devices is equipped with at least one sensor and is configured to communicate notification of condition(s) or event(s) sensed by its sensor(s) to others of said node devices of the mesh network.

19. A system according to claim 18 wherein said at least one sensor comprises at least one of: a temperature sensor, a humidity sensor, an accelerometer, a tilt sensor and a sensor for monitoring status of the battery.

20. A system according to claim 1 wherein at least one node device further comprises at least one light emitter for emitting visible or infrared light.

21. A system according to claim 1 wherein at least one node device has an adhesive surface for adhering that node device to a traffic channelizing/marking device.

22.-28. (canceled)

29. A system according to claim 1 further comprising a solar collector and wherein the electronic circuitry comprises a solar harvester component and apparatus for solar charging of the battery.

30.-56. (canceled)

57. A method for using a device according to claim 1, said method comprising the steps of:
positioning said a plurality of node devices at locations on or near the roadway or path of vehicular travel;
causing or enabling the node devices to communicate as a mesh network; and
causing or enabling the gateway device to receive data from said node devices and to transmit said data or information based on said data to the remotely located control center or data receiver.

58.-61. (canceled)
